(19) United States
(12) Patent Application Publication
(10) Pub. No.: US 2012/0308229 A1
(43) Pub. Date: Dec. 6, 2012

(54) METHOD AND ARRANGEMENT FOR STABILIZING A COLOR CODING METHOD FOR OPTICAL TRANSMISSION OF DATA

(76) Inventors: Michael Bahr, Muchen (DE); Joachim Walewski, Unterhaching (DE)

(21) Appl. No.: 13/577,928

(22) PCT Filed: Feb. 7, 2011
(86) PCT No.: PCT/EP2011/051753

§ 371 Date: Aug. 9, 2012

(30) Foreign Application Priority Data
Feb. 9, 2010 (EP) 10001317.6

(51) Int. Cl. H04B 10/10

(52) U.S. Cl. 398/25; 398/119

(57) ABSTRACT

A method for optically transmitting data between a transmitter and a receiver is provided, wherein a color coding method based on a plurality of elementary colors is provided for encoding and transmitting the data, wherein each elementary color is transmitted by a transmitter-side optical radiation source and is received on the receiver side by an optical radiation receiver. The method includes transmitting a training request message comprising calibration information formed on the transmitter side; forming a channel properties matrix by the receiver from the calibration information and storing the channel properties matrix in the receiver; calculating at least one compensation information on the basis of a reference channel properties matrix stored in the receiver and the reference channel properties matrix; and transmitting the compensation information from the receiver to the transmitter.

### CROSS-REFERENCE TO RELATED APPLICATIONS

This application is a U.S. National Stage Application of International Application No. PCT/EP2011/051753 filed Feb. 7, 2011, which designates the United States of America, and claims priority to EP Patent Application No. 10001317.6 filed Feb. 9, 2010. The contents of which are hereby incorporated by reference in their entirety.

### TECHNICAL FIELD

This disclosure relates to a method and an arrangement for stabilizing a color coding method for optical data transmission.

### BACKGROUND

Data transmission by means of visible light (visible light communications, VLC) is known and can be used, for example, in addition to conventional radio technology. Data can be transmitted, for example, by means of light-emitting diodes (LEDs). A data stream to be transmitted is transferred in the form, for example, of modulations that are not perceptible to the human eye.

Furthermore, a relatively recent coding method for visible light based on color coding with primary colors is known. A method of this type is also known in the specialized field under the heading of CSK (‘color shift keying’). Further older designations for this coding method are CCM (color code modulation) and CMC (color multiplex coding).

A functional principle of VLC using this color coding method is that an illumination mixed from a plurality of primary colors is used for the additional transmission of data, the momentary mix color from the primary colors being rapidly modulated about a common “color center of gravity” and that only the unchanging mix color, specifically that of the color center of gravity, is detectable to the human eye. Usually, for this purpose, the three primary colors red, green and blue are used, as emitted in a technically long-established manner, by corresponding light-emitting diodes.

A detailed description of CSK is contained in the proposed amendment to the IEEE standard 802.15.7, Yokoi et al.: “Modified Text Clause 6.9.2.2”, Jan. 17, 2010, document identification “15-10-0036-00-0007”. One of the applications proposed for CSK is VLC, that is, free-space communication with light.

In said proposed amendment, an automatic compensation on the receiver side for changes in the optical output of the primary color-LEDs provided on the transmitter side is described. Such changes are produced, for example, by ageing effects in the individual LEDs which, given increasing operating duration, output a reduced optical output for the same electrical input power. A change of this type is associated with a change in the quantum efficiency of the transmitter. Compensation of the mix color, that is, the spectrum of the transmitted radiation averaged over time is naturally not provided according to said proposed amendment due to the compensation purely on the receiver side.

There is therefore a need to compensate for changes in the optical output of the primary color LEDs provided, not on the receiver side, for example, by adjusted sensitivity of radiation receivers, but on the transmitter side, by an increasing supply of electrical energy as the quantum efficiency declines.

### SUMMARY

In one embodiment, a method is provided for stabilizing a color coding method for the optical transmission of data between a transmitter and a receiver, wherein for coding and transmission of the data, a color coding method based on a plurality of primary colors is provided, wherein each primary color is transmitted by at least one optical radiation source on the transmitter side and is received by at least one optical radiation receiver on the receiver side, and comprising (a) transmission from the transmitter to the receiver of a training request message comprising calibration information and formed on the transmitter side; (b) formation by the receiver of a channel property matrix from the calibration information and storage of the channel property matrix in the receiver; (c) calculation of at least one item of compensation information based on a reference channel property matrix and the reference channel property matrix stored in the receiver; and (d) transmission of the compensation information from the receiver to the transmitter.

In a further embodiment, the following steps are carried out before method step a): a1) transmission of a compensation request message comprising calibration information and formed on the transmitter side, from the transmitter to the receiver, a2) formation of a reference channel property matrix from said calibration information by the receiver and storage of the reference channel property matrix in the receiver, and a3) transmission of an acknowledgement message in response to the compensation request message from the receiver to the transmitter.

In a further embodiment, based on the compensation information in the transmitter, an adjustment of at least one transmission parameter is undertaken. In a further embodiment, the compensation information is a numerical vector comprising the diagonal elements of a matrix resulting from a left-sided multiplication of the inverted channel property matrix with the reference channel property matrix. In a further embodiment, the compensation information from the receiver to the transmitter is only sent if at least one vectorial element of the compensation information takes a value which essentially corresponds to a value not equal to one. In a further embodiment, at least one vectorial element of the compensation information takes a value not equal to one if the value of the vectorial element overshoots or undershoots the limits of a predeterminable confidence interval by a value of one. In a further embodiment, at least one secondary diagonal element of a matrix resulting from a multiplication of the inverted channel property matrix by the reference channel property matrix is tested as to whether the at least one secondary diagonal element substantially deviates from a value of zero. In a further embodiment, in the case of a substantial deviation of at least one secondary diagonal element of the matrix, an error message is transmitted. In a further embodiment, the training request message comprises an identification which indicates, for a value of 0x0f, an alternating current-related training request message and, for a value of 0x10, a combined direct current-related and alternating current-related training request message. In a further embodiment, transmission of the compensation information by the receiver to the transmitter is carried out by means of a compensation information message. In a further embodiment, the compensation information message comprises an identifier which indicates, for a value of 0x0f, an alternating current-related compensation information message and, for a value of 0x10, a combined direct current-related and alternating current-related compensation information message. In a further embodiment, the acknowledgement message comprises an identifier which indicates, for a value of 0x0f, an alternating current-related acknowledgement message and, for a value of 0x10, a combined direct current-related and alternating current-related acknowledgement message. In a further embodiment, the acknowledgement message comprises status and/or output feature information. In a further embodiment, the method comprises the alternative step of a3) transmission of an acknowledgement message in response to the compensation request message, from the receiver to the transmitter with an entry which indicates that the receiver is at least temporarily in a position to carry out a color stabilization method with regard to the alternating current characteristic and/or with regard to the direct current and alternating current characteristic of the quantum efficiency.

In another embodiment, an optical transmission system is provided for carrying out any of the methods disclosed above.

### BRIEF DESCRIPTION OF THE DRAWINGS

Example embodiments will be explained in more detail below with reference to figures, in which:

FIG. 1 is a structural illustration of a schematic representation of an optical transmission system according to one embodiment;

FIG. 2 is a diagram of the sequence over time of exchanged messages for the correction of color coding based on an identical change in the quantum efficiency in relation to the alternating current and direct current behavior;

FIG. 3 is a diagram of the sequence over time of exchanged messages for the correction of color coding based on a different change in the quantum efficiency in relation to the alternating current and direct current behavior;

FIG. 4 is a quantum efficiency of a radiation source as a function of an optical radiation output dependent on a driver alternating current supplied;

FIG. 5 is a quantum efficiency of a radiation source as a function of an optical radiation output dependent on a driver direct current supplied.

### DETAILED DESCRIPTION

Some embodiments provide methods and systems for compensation on the transmitter side of the mix color of the transmitted optical radiation.

Some embodiments are based on a method for the optical transmission of data between a transmitter and a receiver, wherein a color coding method based on a plurality of primary colors is provided for the coding and transmission of the data, wherein furthermore each primary color is transmitted by a respective optical radiation source on the transmitter side and, on the receiver side, is received by a respective optical radiation receiver.

In some embodiments, a control loop is formed between the transmitter and the receiver, a training request message containing calibration information being sent by the transmitter to the receiver and, on the basis of the calibration information in the receiver a channel property matrix is formed and stored. On the basis of the channel property matrix and at least one previously stored channel property matrix, also designated the reference channel property matrix, at least one item of compensation information is determined and sent back to the transmitter.

The expressions “transmitter” and “receiver” should be understood to mean that the “transmitter” also functions, apart from having the property of being able, in duplex operation, both to transmit and receive data, as a light source, whereas whilst the “receiver” is able to transmit and receiver data in duplex operation, said receiver is not necessarily operated as a light source. Operation of the transmitter as a light source covers, for example, an embodiment as room illumination or as a display panel.

Some embodiments may enable compensation on the transmitter side of the mix color of the transmitted optical radiation which has become changed, for example, due to an intensity drift of an individual primary color.

Some embodiments make possible a stable color coding, wherein the color drift is compensated for on the transmitter side, which may be advantageous. Further, in some embodiments, the originally set color does not change over time, which may be advantageous.

Compensation of the color drift on the transmitter side may be advantageous in relation to compensation on the receiver side in particular in that said compensation has only to be carried out in a system—that is for example, the room illumination used simultaneously for data transmission—and not in a plurality of receivers—for example portable computers communicating with the room illumination system.

In some embodiments, the transmitter is used, apart from the exchange of data, for room illumination in that the additively mixed primary colors produce a mix color that is temporally constant to the human eye. It should be emphasized, however, that a parallel use of the transmitter as room illumination is not essential in at least some embodiments.

In some embodiments, a method for the optical transmission of data has the exclusive purpose of setting the spectral data of the room illumination through the exchange of calibration messages and/or of compensation information. In an alternative embodiment of this type, the room illumination is to be controlled such that a desired color is set or a color drift in the room illumination is compensated for without the transmission of data serving any purpose going beyond the compensation of this color drift.

According to alternative embodiments, the reference channel property matrix can either have been previously transmitted and stored or can have already been stored in a corresponding factory setting.

According to alternative embodiments, it is provided, on the basis of the compensation information determined, to undertake an adaptation of at least one transmission parameter in the transmitter.

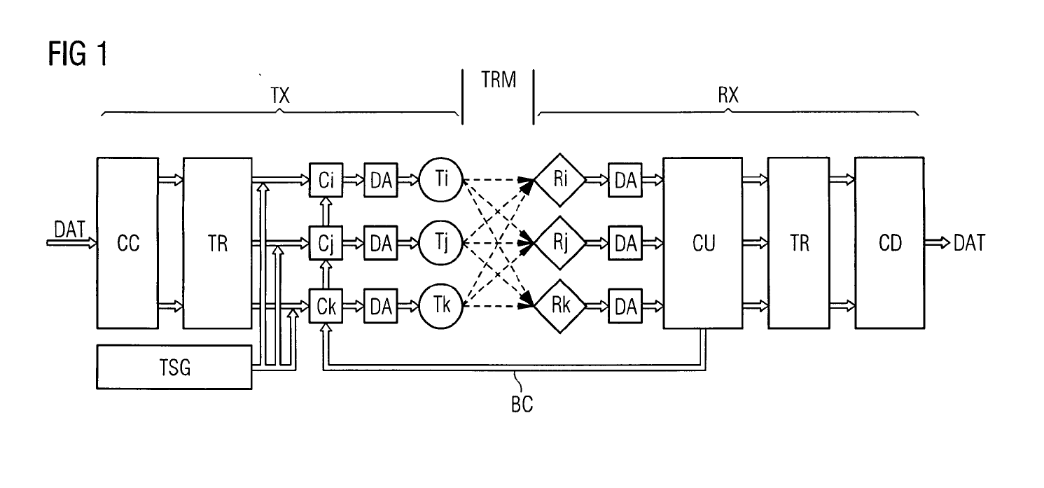

FIG. 1 shows an optical data transmission system for visible light based on a CSK (color shift keying), for example a VLC system (visible light communication).

The data transmission system essentially comprises a transmitter TX, a transmission route TRM and a receiver RX. The transmission system functions in a duplex operation wherein the transmitter TX can both send and receive data. The same applies to the receiver RX.

CSK behavior is based on a color coding with a plurality of primary colors, for example, red, green and blue. A detailed description of CSK is contained in the proposed amendment to the IEEE standard 802.15.7, Yokoi et al.: “Modified Text Clause 6.9.2.2”, Jan. 17, 2010, document identification “15-10-0036-00-0007”.

In FIG. 1, for the sake of simplicity, only the functional units necessary for transmitting are shown on the transmitter side TX and the functional units necessary for receiving are shown on the receiver side RX.

On the transmitter side TX, digital data DAT are initially fed to a color coder CC. The data DAT are converted into XY values in the color coder according to a conversion rule. Said XY values correspond to values in an XY color coordinate system.

At the output of the color coder CC, these two-dimensional data—symbolized in the drawing with two arrows—are fed to a transformer TR, at the output of which three digital intensity data for the intensity of each of the three primary colors are made available.

A digital intensity data is fed, in each case, to a converter DA in which the digital intensity data are converted to analogue intensity data. Said analogue intensity data are fed to a respectively associated optical radiation source Ti, Tj, Tk, that is, a first optical radiation source Ti, a second optical radiation source Tj, and a third optical radiation source Tk.

According to an example embodiment, the first optical radiation source Ti corresponds to a red light-emitting diode, the second optical radiation source Tj corresponds to a green light-emitting diode and the third optical radiation source Tk corresponds to a blue light-emitting diode.

The optical radiation thus emitted by the radiation source Ti, Tj, Tk is conducted via a transmission route TRM in the direction toward the receiver RX.

On the side of the receiver RX, the emitted optical radiation impinges upon respective radiation receivers Ri, Rj, Rk, respectively adjusted to one of the primary colors, specifically a first optical radiation receiver Ri, a second optical radiation receiver Rj and a third optical radiation receiver Rk.

In a similar manner, running contrary to the transmitter TX, in the receiver RX, the respective optical signal is converted by the optical radiation receivers Ri, Rj, Rk into an analogue electric signal which is fed to a respective converter DA in which a respective conversion of the analogue signal into a respective digital signal takes place.

The digital intensity data drawn off from the three respective converters DA are fed to a transformer TR, which, in a manner contrary to the transmitter TX, undertakes conversion of the triplet of values into a pair of values which, in turn, is fed to a color decoder CD, at the output of which, finally, data DAT are extracted, said data being in a correct operating mode identical to the mode of the data DAT fed to the transmitter TX.

A transfer function of a CSK system will now be described. In the usual manner, A denotes a matrix and a denotes a single-column matrix.

In an ideal synchronized CSK system with a ‘flat’ frequency response, the correlation between a digital signal s_{Tx} to be transmitted by the optical radiation sources Ti, Tj, Tk and the digital signal s_{Rx} received by the optical radiation receivers Ri, Rj, Rk can be described as follows:

s_{Rx}=BETQAs_{Tx}=Hs_{Tx} (1)

The vectorially received signal s_{Rx} can comprise, for example, a red, green and blue signal, the index i being assigned to the red signal, the index j being assigned to the green signal and the index k being assigned to the blue signal, i.e.

s_{Rx}=(i_{Rx}j_{Rx}k_{Rx})^{T},

where (.)^{T} is the conjugate matrix of the vector (.).

A conversion matrix B on the receiver side is a diagonal matrix and defines the conversion factor between the analogue and digital receiver signals.

A sensitivity matrix E defines the sensitivity of one of the color-selective radiation receivers Ri, Rj, Rk (photoreceptors) on receiving one of the primary colors. Typically, though not necessarily, just as many radiation receivers Ri, Rj, Rk are used as there are primary color light-emitting diodes, that is, optical radiation sources Ti, Tj, Tk. With the assignment of the index i to ‘red’, j to ‘green’ and k to ‘blue’, the element eᵢᵢ of matrix E is, for example, the sensitivity of the red photoreceptor on reception of the light emitted by the red LED. The sensitivity matrix E therefore takes account of the spectral efficiency of each radiation receiver Ri, Rj, Rk responding to a primary color and also of a color filter possibly provided and, through a corresponding linear combination of the coefficients of the sensitivity matrix E, ‘cross-talk’ between the radiation receivers Ri, Rj, Rk responding to the respective primary colors. An example for such coefficients of the sensitivity matrix E is eᵢⱼ.

A transmittance matrix T defines the optical transmittance of each primary color radiation source Ti, Tj, Tk to a respective radiation receiver Ri, Rj, Rk provided for a different primary color. In other words, the transmittance matrix T defines the propagation characteristics of the light, for example, how much red light transmitted by the first optical radiation source Ti arrives at the third radiation receiver Rk provided for blue light.

A quantum efficiency matrix Q is a diagonal matrix and defines the quantum efficiency of the conversion of the driver current into optical output.

A transmitter-side conversion matrix A is also a diagonal matrix and describes the relationship between the digital signal and the AC driver current fed to the LED.

A channel property matrix H combines the channel properties of the optical transfer route, as given by

H=BETQA

The channel property matrix H is determined by transmitting calibration symbols, as described below. For this purpose, for example, Walsh codings are used.

If the quantum efficiency of the optical radiation sources Ti, Tj, Tk changes over time, that is to say if the ratio of the respectively supplied driver current to the optical output and thus, computationally, the ratio of the quantum efficiency matrix Q to the altered quantum efficiency matrix Q′, then given the same transmitter signals, the received signals and therefore, based on equation (1), also s_{Rx} are altered.

Changes in the quantum efficiency Q result, for example, from temperature changes or an ageing process in the transmitting light-emitting diodes. A change in the quantum efficiency means, for the respective optical radiation source Ti, Tj, Tk, that given the same current, a greater or smaller optical output is radiated.

With the aid of transmitted calibration symbols, an altered channel property matrix H′ is found according to the equation

H′=BETQ′A

This altered channel matrix H′ corrects the received signals, but not the mix color of the transmitted light resulting from the optical overlay of the individual light-emitting diodes. In other words, in conventional systems, no changes are made to the transmission parameters and conventionally compensation takes place exclusively on the receiver side.

In order to correct the transmission parameters, the control loop may be implemented by means of a return channel BC.

On the transmitter side TX, a calibration message generator TSG by means of which digital calibration messages can be applied to the input of a respective converter DA of a respective optical radiation source Ti, Tj, Tk. The calibration messages which are then converted and transmitted via the optical radiation sources Ti, Tj, Tk are decoded accordingly on the receiver side RX and are evaluated by a correction unit CU on the receiver side.

A calibration message contains a plurality of time slots into which orthogonal, e.g., Walsh coded symbols are written. A symbol may be entered into a plurality of successive time slots. Resulting therefrom, for statistical reasons, is an improvement in the evaluation on the part of the receiver if the received value is averaged over a plurality of time slots.

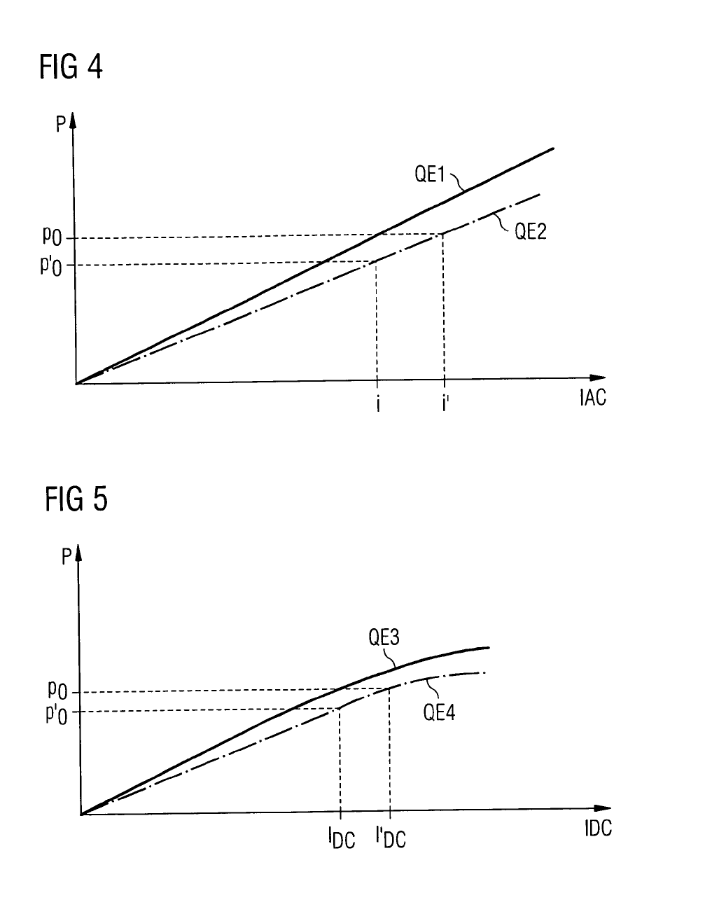

In order to evaluate an alternating current characteristic, which is described below by reference to FIG. 4, it may be advantageous to keep low both the length of the symbols and the number of successive time slots into which the symbol is entered, so that the direct current characteristic of the respective radiation source Ti, Tj, Tk does not affect the evaluated calibration messages.

On the other hand, a plurality of identical symbols transmitted in successive time slots can result in a favorable evaluation of the direct current behavior, as described below by reference to FIG. 5. Overall, however, the calibration messages should not exceed a temporal length of about 10 milliseconds, since otherwise the human eye will perceive a flickering of the radiation source Ti, Tj, Tk used also as room illumination.

By means of a comparison of the at least one channel property of at least one received calibration message with a corresponding channel property of at least one previously transmitted or stored calibration message, a compensation factor is determined in the correction unit CU of the receiver RX.

For this purpose, the channel matrix H which, as described above, defines a plurality of channel properties, is stored by the correction unit CU on the receiver side RX at the beginning of a sequence of calibration signal data as a reference channel property matrix H₀, or is already present on the receiver side RX. After a plurality i of calibration message cycles, on the ith calibration, newly estimated values for Hᵢ are compared with the old values of the reference channel property matrix H₀. A left-side multiplication of the inverted channel property matrix with the reference channel property matrix results in a matrix C wherein C=Hᵢ⁻¹H₀.

If the difference of C_{S} diagonal elements exceeds a predetermined value, then a numerical vector c=diag(Hᵢ⁻¹H₀) is returned to the transmitter. The calculation operator (.) indicates a single-column vector comprising the diagonal elements of a matrix (.). In the present exemplary embodiment, the numerical vector c therefore unifies three compensation factors for the three primary colors.

A possible criterion for the initiation of this process is the comparison of the values of c with the unit vector. If the relevant differences between at least one of the vectorial elements of c are larger than the limits of a pre-definable confidence interval by the value one, or 1±0.05, then a compensation is initiated in the transmitter. Such a value can be determined, for example, on the basis of the determination of a histogram of c and a pre-defined, adjustable and/or previously determined confidence interval. If the comparison of the values of the numerical vector of c with the unit vector reveals a difference which is, for example, greater than the upper limit of the confidence interval, said process is initiated.

For example, based on the vectorial compensation factor c determined, compensation information—not shown—is transmitted by the correction unit CU of the receiver RX to the transmitter TX.

If the secondary diagonal elements of the matrix C=(Hᵢ⁻¹H₀) are not equal to zero, then said elements can be attributed to other fault causes, for example, blocking in the ‘crosstalk’ of Ti and Tj to Rk. In this event, it is provided in one embodiment that, in place of the compensation information or in addition to the compensation information, an error message is to be conveyed to the transmitter TX. The transmitter TX can then output a suitable warning concerning a possible fault function to an identifiable receiver RX or to higher communication layers.

In the receiver the digital signals to be transmitted are then multiplied by the relevant values of c by interpolating a respective correction element Ci, Cj, Ck so that the mix color of the output light matches the original color.

The reference matrix H₀ originally stored in the correction unit CU on the receiver side RX can now be used again on the receiver side as a ‘decoding matrix’.

A key concept is therefore that, by comparing the compensation matrix Hᵢ with the original compensation matrix H₀ and by transmitting compensation factors c back to the transmitter, a color drift in the transmitter can be compensated for.

By this means, a CSK-modulated optical free-space system can be used simultaneously for illumination and/or for signaling purposes.

According to one embodiment, a distinction is made between, firstly, a change in H due to a movement of the transmitter and the receiver relative to one another and, secondly, a color shift, in that in the first case, a relative movement between the transmitter and the receiver is equal to a relative change in the values of c, whilst in the case of a color shift according to the aforementioned second case, this is not so.

In the case of a relative movement between the transmitter and the receiver, no correction value is transmitted by the receiver to the transmitter. However, H₀ is replaced with Hᵢ.

In another embodiment, the values of |s_{TX}| thus corrected are upwardly limited in order to prevent overloading of the LED. In the usual manner, |.| is the vector of absolute values of s_{TX}. These limit values can be, for example, specified by the manufacturer or can be calculated from the recommended LED driver currents if the matrix A is known.

It is important to note that the proposed method also functions in the case of strictly monotonic non-linearity between the driver current for the LED and the optical output. If a simply linear relation about an operating point is assumed, then the compensation described above may be carried out a plurality of times in succession until a stable value for c is produced.

If the color center of gravity in a CSK diagram is deliberately displaced, a new H₀ must be determined. Given an unchanged color center of gravity, the compensation process described above can then be used again.

If the spectrum of the system transfer function is not ‘flat’, the formalism described above can be changed as follows:

All the symbols in the above equations are replaced with the Fourier transform of the pulse responses, or

s_{Rx}→ [symbol] [s_{Rx}(t)] (3)

where [symbol] [.] is a Fourier transform of [.] and t is a time variable. Equation (3) is evaluated for the frequency at which a convex function of the vector [symbol] [s_{Rx}(t)] takes a maximum value. With the aid of this function, the frequency representation of H is calculated and this is denoted as H_{F}.

An example of a convex function of this type is

[symbol]

[s_{R,Rx}(t)]²+ [symbol] [s_{G,Rx}(t)]²+ [symbol] [s_{B,Rx}(t)]² (4)

In place of H, H_{F} is used for the above-described determination of c.

It should also be noted that the above described compensation method can also be used if no useful data are determined. For this purpose, calibration symbols need only to be sent at particular intervals and the matrix Hᵢ estimated.

In FIG. 4, a function of the optical radiation output P of a radiation source Ti, Tj, Tk is shown graphically against a supplied driver alternating current IAC, also designated the quantum efficiency. It is assumed that this function is approximately linear.

The solid line shown in FIG. 4 corresponds to an original quantum efficiency QE1, which changes in the course of the operation of the radiation source, in this case for example, lessens, shown by the dot-dashed line thereunder according to an altered quantum efficiency QE2.

This changed quantum efficiency QE2 has the result that, for a given driver alternating current i, the original optical output p₀ falls to a lower value p₀′. In order to come back to the original optical output p₀, the driver alternating current must be changed to a higher value i′.

With regard to the quantum efficiency matrix Q, the diagonal elements thereof are proportional to the quantum efficiency of a respective radiation source Ti, Tj, Tk.

A change in the quantum efficiency of individual radiation sources Ti, Tj, Tk therefore leads to an alteration in the quantum efficiency matrix Q to a changed quantum efficiency matrix Q′ and correspondingly to a changed channel property matrix H′.

FIG. 5 shows a function of the optical radiation output P of a radiation source Ti, Tj, Tk as a function of a supplied driver direct current IDC. In practical implementations, the light-emitting diodes used for the radiation sources have a quantum efficiency for direct currents which differs from the quantum efficiency for alternating currents as in FIG. 4. Reasons for this are, for example, a thermal inertia and any saturation effects arising in the light-emitting diode.

As previously mentioned, for the determination of the channel property matrix H in relation to the alternating current behavior, orthogonal codes, particularly modified Walsh codes, can be used.

A similar approach can be used for estimating the correction factors for direct currents or working currents (bias current) of the light-emitting diode. For this purpose, the time slots of the orthogonal code used are sent via the optical radiation source sufficiently often until said radiation source reaches thermal equilibrium. In order to determine the channel property matrix with regard to the direct current behavior, a plurality of time slots of the calibration message are thus each given an identical symbol.

The last received values at the end of a Walsh code slot are used for estimating a direct current channel property matrix H_{DC}. The respective channel property matrices are then used in similar manner for the determination of the correction value c_{DC}=diag)H_{DCi}⁻¹H_{DC0}).

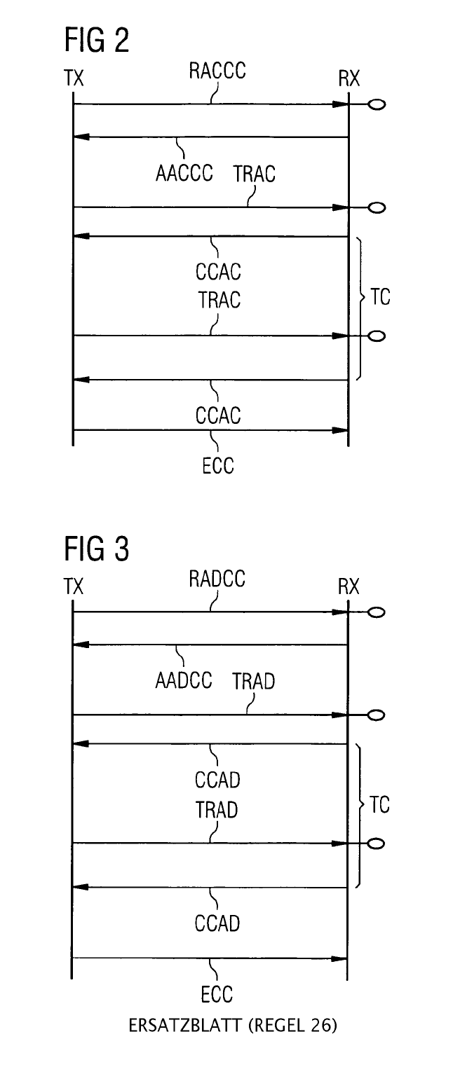

A temporal flow diagram of exchanged messages for correcting the color coding will now be described by reference to FIGS. 2 and 3. Without limiting generality, an exchange of messages between the transmitter TX and the receiver RX is assumed, the participating functional units in the transmitter TX and the receiver RX not being stipulated.

To illustrate the message exchange as shown in FIGS. 2 and 3, messages are shown running in the horizontal direction between the transmitter TX and the receiver RX, the respective messages being illustrated in a temporal order wherein the older messages are each shown above the newer messages.

Firstly, in FIG. 2, the exchange of messages carried out for execution of a method for stabilizing the color coding is shown, by means of which a change in the quantum efficiency of the light source on the transmitter side is compensated for, wherein, according to the previously described FIG. 4, the alternating current characteristic of the quantum efficiency matches the direct current characteristic of the quantum efficiency. Thus, in this case, the direct current characteristics of the quantum efficiency and the alternating current characteristics of the quantum efficiency have identical gradients.

To initiate the method, the transmitter TX transmits a compensation request message RACCC to the receiver RX. The compensation request message RACCC may be identified with the expression ‘Request AC Color Compensation’.

The compensation request message RACCC contains calibration information assembled on the transmitter side which is also designated ‘AC Training Frame’. This calibration information is placed in a header (message header entry) of a data packet at the hardware level (‘physical layer’) or, alternatively in a header in the data link layer or MAC (‘Media Access Control’) layer of the data packet comprising the compensation request message RACCC. The calibration information serves to provide to the receiver RX with a calculation and/or estimation of the currently available channel properties. The corresponding values of the channel matrix are stored in a reference channel property matrix H₀.

After storage of the reference channel property matrix H₀ in the receiver RX, said receiver sends an acknowledgement message AACCC to the transmitter TX. Said acknowledgement message may be designated with the abbreviation ‘Ack AC’ (‘Acknowledge’).

With the acknowledgement message AACCC, the receiver RX simultaneously confirms that, apart from successful reception of the compensation request message RACCC, the receiver is in a position to carry out the color stabilization method described here with regard to the alternating current characteristic of the quantum efficiency. The acknowledgement message AACCC can also contain additional status and/or performance feature information, although said information is not set out in detail below.

If the acknowledgement message AACCC is omitted or returned to the transmitter TX with a corresponding negative entry, this implies that the receiver RX is not in a position to carry out the color stabilization method according to the alternating current characteristic of the quantum efficiency. If the acknowledgement message AACCC is not received at the sender TX within a pre-defined waiting period, it is provided that the transmitter TX transmits a new compensation request message RACCC—not shown—to the receiver RX. Said pre-defined waiting period may also be identified with the abbreviated designation ‘macAckColorCompWaitTime’.

Following receipt of the acknowledgement message AACCC, a training request message TRAC is sent by the transmitter TX to the receiver RX. Said training request message TRAC may be identified with the abbreviated designation ‘Training AC’. The training request message TRAC contains calibration information required for the color stabilization method with regard to the alternating current characteristic of the quantum efficiency.

With the aid of the training request message TRAC, the present channel properties on the receiver side are derived or calculated and stored in a channel property matrix H′.

In contrast to a receiver-side compensation scheme which is set out in the proposed amendment to the IEEE standard 802.15.7, Yokoi et al.: “Modified Text Clause 6.9.2.2”, Jan. 17, 2010, document identification “15-10-0036-00-0007”, the present channel property matrix H′ does not serve as the basis of a compensation (‘equalization’) for spectral changes to the optical output, but rather the reference channel property matrix H₀ stored on the receiver side serves this purpose. On the basis of the channel property matrix H′ and the reference channel matrix H₀, compensation information or, put more precisely, a compensation vector c is calculated in the receiver RX, said compensation vector being sent by the receiver RX to the transmitter TX with the aid of a compensation information message CCAC.

The compensation information message CCAC may be identified with the expression ‘AC Compensation Coefficients’. Following receipt and evaluation of said compensation information message CCAC in the transmitter TX, the transmitter decides whether a correction is appropriate. If the decision is positive, the vectorial elements of the compensation vector c are multiplied in the correction elements Ci, Cj, Ck shown in FIG. 1.

Following a pre-defined cycle time TC, the transmitter TX again transmits a training request message TRAC as described above, whereupon the receiver RX updates the present channel property matrix H′, calculates the compensation vector c and sends the result back to the transmitter TX with a further compensation information message CCAC.

This cycle is repeated at a frequency that corresponds to the inverse of the cycle time TC. The repetition takes place until the transmitter TX transmits a termination message ECC to the receiver RX. Said termination message ECC may be identified with the expression ‘end color compensation’.

A message exchange carried out during the performance of a method for stabilizing the color coding, with the aid of which a change in the quantum efficiency of the light source on the transmitter side is compensated for will now be described making reference to FIG. 3, wherein, as per the previously described FIG. 5, the direct current characteristic and the alternating current characteristic of the quantum efficiency, which differs therefrom, are to be compensated for. The alternating current characteristic of the quantum efficiency therefore does not agree—in contrast to the method previously described by reference to FIG. 2—in the method on which this message exchange is based, with the direct current characteristic of the quantum efficiency.

To initiate the method, the transmitter TX transmits a compensation request message RADCC to the receiver RX. The compensation request message RADCC may be identified with the expression ‘Request AC & DC color compensation’.

The compensation request message RADCC comprises calibration information formed on the transmitter side and identified as ‘AC & DC Training Frame’. This calibration information is contained in a header (message header entry) of a data packet at the hardware level (‘physical layer’), or alternatively, in a header at the security layer or the MAC (‘media access control’) layer of the data packet forming the compensation request message RADCC. The calibration information serves to perform a calculation and/or an estimate of the current channel properties for the receiver RX. The corresponding values of the respective channel matrix for the alternating current behavior and for the direct current behavior are stored in two reference channel property matrices H₀ and H_{0DC}.

After storage of the reference channel property matrices H₀ and H_{0DC} in the receiver RX, the receiver transmits an acknowledgement message AADCC to the transmitter TX. Said acknowledgement message may be identified with the abbreviated designation ‘Ack AC & DC’.

With the acknowledgement message AADCC, apart from successful reception of the compensation request message RADCC, the receiver RX simultaneously thereby confirms being in a position to carry out the described color stabilization method with regard to the combined direct current and alternating current characteristics of the quantum efficiency. The acknowledgement message AADCC can also contain additional status and/or performance characteristic information, although these will not be described in detail here.

If said acknowledgement message AADCC is not sent or is returned with a corresponding negative entry to the transmitter TX, this means that the receiver RX is not in a position to carry out a color stabilization method with regard to the direct current characteristic and the alternating current characteristic of the quantum efficiency. If the acknowledgement message AADCC is not received by the transmitter TX within a pre-defined waiting period, it is provided that the transmitter TX transmits a new compensation request message RADCC—not shown in FIG. 3—to the receiver RX. Said pre-defined waiting time may be identified with the abbreviated designation ‘macAckColorCompWaitTime’.

Following receipt of the acknowledgement message AADCC, a training request message TRAD is sent by the transmitter TX to the receiver RX. Said training request message TRAD may be identified with the abbreviated designation ‘Training AC & DC’. The training request message TRAD contains the calibration information necessary for the color stabilization method regarding the direct current and alternating current characteristics of the quantum efficiency.

With the aid of the training request message TRAD, the present channel properties are derived or calculated, on the receiver side, and stored in a respective channel property matrix H′ and H′_{DC}.

In contrast to a compensation scheme on the receiver side which is set out in the proposed amendment to the IEEE standard 802.15.7, Yokoi et al.: “Modified Text Clause 6.9.2.2”, Jan. 17, 2010, document identification “15-10-0036-00-0007”, it is not the present channel property matrices H′ and H′_{DC} which serve as the basis for a compensation (‘equalization’) for spectral changes to the optical output, but rather the reference channel property matrices H₀ and H_{0DC} stored on the receiver side. Based on the channel property matrices H′ and H′_{DC} and the reference channel property matrices H₀ and H_{0DC}, compensation information, or more precisely respective compensation vectors c and c_{DC} which are transmitted by the receiver RX to the transmitter TX with the aid of a compensation information message CCAD are calculated in the receiver RX.

The compensation information message CCAD may be identified with the designation ‘AC & DC Compensation Coefficients’. After receipt and evaluation of this compensation information message CCAD in the transmitter TX, said transmitter decides whether a correction is suitable. If the decision is positive, the vectorial elements of the compensation vectors c and c_{DC} are multiplied in the correction elements Ci, Cj, Ck. Herein, the DC values of the driver current, also known as the bias current, are multiplied with the corresponding values of c_{DC} whilst the information-bearing AC values of the driver current are multiplied with the corresponding values of c.

After a pre-defined cycle time TC, the transmitter TX transmits a new training request message TRAD as described above, whereupon the receiver RX updates the present channel property matrix H′, calculates the compensation vector c and sends the result back to the transmitter TX with a further compensation information message CCAD.

This cycle is repeated at a frequency which corresponds to the inverse of the cycle time TC. The repetition takes place until the transmitter TX transmits a termination message ECC to the receiver RX. Said termination message ECC may be identified with the designation ‘End Color Compensation’.

A structure of the above described messages will now be described making reference to an example embodiment. The structure of the messages is configured on the basis of and in continuation of the proposed standard IEEE 802.15.7, issue 2009: ‘IEEE Standard for Information Technology—Telecommunications and Information Exchange between Systems—Local and Metropolitan Area Networks—Specific Requirements—Part 15.7: Wireless Medium Access Control (MAC) and Physical Layer (PHY) Specifications for Visible Light Wireless Personal Area Networks (WPANs)’.

Firstly, based on the following Table 1, an identifier is introduced (‘Command-frame identifier’) which states whether the messages into which the respective identifier is inserted are used within the context of stabilization of the alternating current characteristic (‘AC Color Stabilization’) or within the context of a combined stabilization of the direct current characteristic and of the alternating current characteristic (‘AC & DC color stabilization’) of the quantum efficiency. In the table, the identifier is given with the associated designation (‘Command name’) thereof.

TABLE 1

| Command-frame | |
|---|---|
| identifier | Command name |
| 0x0f | AC color stabilization |
| 0x10 | AC & DC color stabilization |

A group of messages (‘Command frame’) included under the heading ‘Color stabilization command’ will now be described under the heading ‘Color stabilization’, the general structure of said group being shown in the second line of Table 2 below. The first line of Table 2 shows the size of the information length of the respective fields in said structure, measured in ‘Octets’.

TABLE 2

| Octets | 1 | 1 | Variable |
|---|---|---|---|
| MHR fields | Command-frame | Color- | Command- |
| | identifier | stabilization | specific |
| | | command identifier | information |

The fields of the message header entry (‘Message Header’, MHR), that is, the ‘MHR fields’ show, in this sequence, the identifier defined in Table 1 (‘Command-frame identifier’) with a length of 1 octet, a method identifier (‘Color stabilization command identifier’) defined in Table 3 below with a length of 1 octet and a method argument (‘Command-specific information’) with a variable length (‘Variable’). The column and row sequence shown in Table 2 is not essential; in alternative embodiments, another arbitrary sequence may be provided.

Table 3 below shows possible method identifiers (‘Color stabilization command identifier’) together with the respective message types thereof (‘Color stabilization command’)

TABLE 3

| Color-stabilization | |
|---|---|
| command identifier | Color-stabilization command |
| 0x00 | Request color compensation |
| 0x01 | Acknowledge color compensation |
| 0x02 | Color-compensation training |
| 0x03 | Color-compensation coefficients |
| 0x04 | End color compensation |

The structure of the messages known from FIGS. 2 and 3 will now be described by reference to the above system.

The alternating current-related compensation request message RACCC, which may be identified with the expression ‘Request AC Color Compensation’, is used for initiating a color stabilization method with regard to the alternating current characteristic of the quantum efficiency, in the course of which transfer of alternating current-related compensation information takes place. The structure of this alternating current-related compensation request message RACCC follows the general structure as per Table 2 and is shown, in the specific configuration thereof, in Table 4 below.

TABLE 4

| Octets | 1 | 1 | 0 |
|---|---|---|---|
| MHR fields | Command-frame | Color-stabilization | N/A |
| | identifier for | command identifier | |
| | ‘AC color | ‘Request color | |
| | stabilization’ | compensation’ | |

In Table 4 as the identifier (‘Command-frame identifier’), the identifier 0x0f defined in Table 1 with the designation ‘AC color stabilization’ is entered. As the method identifier, in Table 4 the method identifier 0x00 defined in Table 3 with the designation ‘Request color compensation’ is entered. A further field (with an information length of zero octets) is not used and is therefore identified with ‘N/A’ or ‘not applicable’.

The direct current and alternating current-related compensation request message RADCC, e.g., with the expression ‘Request AC & DC Color Compensation’, is used to initiate a color stabilization method with regard to a combined direct current and alternating current characteristic of the quantum efficiency, in the course of which, an item of direct current-related and an alternating current-related compensation information is transferred. The structure of this alternating current-related compensation request message RADCC follows the general structure as per Table 2 and the specific configuration thereof is shown in Table 5 below.

TABLE 5

| Octets | 1 | 1 | 0 |
|---|---|---|---|
| MHR fields | Command-frame | Color-stabilization | N/A |
| | identifier for | command identifier | |
| | ‘AC & DC color | ‘Request color | |
| | stabilization’ | compensation’ | |

In Table 5 as the identifier (‘Command-frame identifier’), the identifier 0x10 defined in Table 1 with the designation ‘AC & DC color stabilization’ is entered. As the method identifier, in Table 5 the method identifier 0x00 defined in Table 3 with the designation ‘Request color compensation’ is entered. A further field (with an information length of zero octets) is not used and is therefore identified with ‘N/A’ or ‘not applicable’.

The alternating current-related acknowledgement message AACCC, which may be identified with the expression ‘Ack AC’, is used to acknowledge the successful reception of the compensation request message RACCC and simultaneously to confirm that the requested color stabilization method can be carried out on the receiver side. The structure of this alternating current-related acknowledgement message AACCC follows the general structure as per Table 2 and the specific configuration thereof is shown in Table 6 below.

TABLE 6

| Octets | 1 | 1 | User-defined |
|---|---|---|---|
| MHR fields | Command-frame | Color- | User-defined |
| | identifier for | stabilization | (additional |
| | ‘AC color | command identifier for | status and |
| | stabilization’ | ‘Acknowledge | capability |
| | | color compensation’ | information) |

In Table 6 as the identifier (‘Command-frame identifier’), the identifier 0x0f defined in Table 1 with the designation ‘AC color stabilization’ is entered. As the method identifier, in Table 6 the method identifier 0x01 defined in Table 3 with the designation ‘Acknowledge color compensation’ is entered. A further field with a definable information length (‘User-defined’) optionally contains status and/or output feature information.

The direct current-related and alternating current-related acknowledgement message AADCC, which may be identified with the expression ‘Ack AC & DC’, is used to acknowledge the successful reception of the compensation request message RADCC and simultaneously to confirm that the requested color stabilization method can be carried out on the receiver side. The structure of this direct current-related and alternating current-related acknowledgement message AADCC follows the general structure as per Table 2 and the specific configuration thereof is shown in Table 7 below.

TABLE 7

| Octets | 1 | 1 | User-defined |
|---|---|---|---|
| MHR fields | Command-frame | Color-stabilization | User-defined |
| | identifier for | command identifier for | (additional |
| | ‘AC & DC color | ‘Acknowledge | status and |
| | stabilization’ | color compensation’ | capability |
| | | | information) |

In Table 7 as the identifier (‘Command-frame identifier’), the identifier 0x10 defined in Table 1 with the designation ‘AC & DC color stabilization’ is entered. As the method identifier in Table 7, the method identifier 0x01 defined in Table 3 with the designation ‘Acknowledge color compensation’ is entered. A further field with a definable information length (‘User-defined’) optionally contains status and/or output feature information.

The alternating current-related training request message TRAC, which may be identified with the expression ‘Training AC’, contains the calibration information necessary for the color stabilization method in relation to the alternating current characteristic of the quantum efficiency. The structure of this direct current-related training request message TRAC follows the general structure as per Table 2 and the specific configuration thereof is shown in Table 8 below.

TABLE 8

| Octets | 1 | 1 | Implementer-defined |
|---|---|---|---|
| MHR fields | Command-frame | Color- | Length of training |
| | identifier for | stabilization | sequence is dependent |
| | ‘AC color | command | on chosen code |
| | stabilization’ | identifier for | sequences and other |
| | | ‘Color | implementation |
| | | compensation | choices. Also, the |
| | | training’ | training sequences |
| | | | can be made part of |
| | | | the PHY header. |
| | | | However, in this |
| | | | text, we only describe |
| | | | a MAC-layer |
| | | | implementation |

In Table 8 as the identifier (‘Command-frame identifier’), the identifier 0x0f defined in Table 1 with the designation ‘AC color stabilization’ is entered. As the method identifier, in Table 8 the method identifier 0x02 defined in Table 3 with the designation ‘Color-compensation training’ is entered. A further field with a definable information length (‘Implementer-defined’) contains calibration information formed on the sender side. The length of said field is dependent on the length of the training sequences, which in turn depends on selected code sequences and other implementation details. In this embodiment, it is assumed that the calibration information is present in the header or MHR (‘Message Header’) of the training request message TRAC shown in Table 8, that is, on the security or MAC (‘Media Access Control’) layer. Alternatively, said information is present in the header of a data packet at hardware level (‘Physical layer’).

The direct current-related and alternating current-related training request message TRAD, which may be identified with the expression ‘Training AC & DC’, contains the calibration information necessary for the color stabilization method in relation to the combined direct current and alternating current characteristic of the quantum efficiency. The structure of this alternating current-related training request message TRAC follows the general structure as per Table 2 and the specific configuration thereof is shown in Table 9 below.

TABLE 9

| Octets | 1 | 1 | Implementer-defined |
|---|---|---|---|
| MHR fields | Command-frame | Color- | Length of training |
| | identifier for | stabilization | sequence is dependent |
| | ‘AC & DC color | command | on chosen code |
| | stabilization’ | identifier for | sequences and other |
| | | ‘Color | implementation |
| | | compensation | choices. Also, the |
| | | training’ | training sequences |
| | | | can be made part of |
| | | | the PHY header. |
| | | | However, in this |
| | | | text, we only describe |
| | | | a MAC-layer |
| | | | implementation |

In Table 9 as the identifier (‘Command-frame identifier’), the identifier 0x10 defined in Table 1 with the designation ‘AC & DC color stabilization’ is entered. As the method identifier in Table 9, the method identifier 0x02 defined in Table 3 with the designation ‘Color-compensation training’ is entered. A further field with a definable information length (‘Implementer-defined’) contains calibration information formed on the sender side. The length of said field is dependent on the length of the training sequences, which in turn depends on selected code sequences and other implementation details. In this embodiment, it is assumed that the calibration information is present in the header or MHR (‘Message Header’) of the training request message TRAD shown in Table 9, that is, on the security or MAC (‘Media Access Control’) layer. Alternatively, said information is present in the header of a data packet at hardware level (‘Physical layer’).

The alternating current-related compensation information message CCAC, which may be identified with the expression ‘AC Compensation Coefficients’, is used for transferring the compensation information, or more precisely, the alternating current-related compensation vector c, from the receiver RX to the transmitter TX. The structure of this alternating current-related information message CCAC follows the general structure as per Table 2 and the specific configuration thereof is shown in Table 10 below.

TABLE 10

| Octets | 1 | 1 | 6 |
|---|---|---|---|
| MHR fields | Command-frame | Color-stabilization | AC compensation |
| | identifier for | command identifier | factor vector |
| | ‘AC color | for ‘Color | |
| | stabilization’ | compensation | |
| | | coefficients’ | |

In Table 10 as the identifier (‘Command-frame identifier’), the identifier 0x0f defined in Table 1 with the designation ‘AC color stabilization’ is entered. As the method identifier, in Table 8 the method identifier 0x03 defined in Table 3 with the designation ‘Color-compensation coefficients’ is entered. A further field with an information length of six octets contains the vectorial values of the alternating current-related compensation vector c.

The direct current-related and alternating current-related compensation information message CCAD, which may be identified with the expression ‘AC & DC compensation coefficients’, is used for transferring the compensation information, or more precisely, the direct current-related and alternating current-related compensation vectors c and c_{DC}, from the receiver RX to the transmitter TX. The structure of this alternating current-related compensation information message CCAD follows the general structure as per Table 2 and the specific configuration thereof is shown in Table 11 below.

TABLE 11

| Octets | 1 | 1 | 6 | 6 |
|---|---|---|---|---|
| MHR | Command- | Color | AC | DC |
| fields | frame | stabilization | compensation | compensation |
| | identifier: | command | factor vector | factor vector |
| | for ‘AC & | identifier | | |
| | DC color | for ‘Color | | |
| | stabilization’ | compensation | | |
| | | coefficients’ | | |

In Table 11 as the identifier (‘Command-frame identifier’), the identifier 0x10 defined in Table 1 with the designation ‘AC & DC color stabilization’ is entered. As the method identifier, in Table 11 the method identifier 0x03 defined in Table 3 with the designation ‘Color-compensation coefficients’ is entered. A further field with an information length of six octets contains the vectorial values of the alternating current-related compensation vector c. A further field with an information length also of six octets contains the vectorial values of the direct current-related compensation vector c_{DC}.

The termination message ECC, which may be identified with the expression ‘End color compensation’ is used for ending the color stabilization method. The structure of this alternating current-related termination message ECC follows the general structure as per Table 2 and the specific configuration thereof is shown in Table 12 below.

TABLE 12

| Octets | 1 | 1 | 0 |
|---|---|---|---|
| MHR fields | Command-frame identifier: | Color-stabilization | N/A |
| | for ‘AC color stabilization’ | command identifier for | |
| | or ‘AC & DC color | ‘End color | |
| | stabilization’, depending | compensation’ | |
| | on what stabilization | | |
| | process to be terminated | | |

In Table 12 as the identifier (‘Command-frame identifier’), depending on the type of color stabilization process to be terminated, the identifier 0x0f defined in Table 1 with the designation ‘AC color stabilization’ or the identifier 0x10 with the designation ‘AC & DC color stabilization’ is entered. As the method identifier in Table 12, the method identifier 0x04 defined in Table 3 with the designation ‘End color compensation’ is entered. A further field (with an information length of zero octets) is not used and is therefore identified with ‘N/A’ (‘not applicable’).

1. A method for stabilizing a color coding method for the optical transmission of data between a transmitter (TX) and a receiver (RX),
wherein for coding and transmission of the data, a color coding method based on a plurality of primary colors is provided, wherein each primary color is transmitted by at least one optical radiation source (Ti, Tj, Tk) on the transmitter side and is received by at least one optical radiation receiver (Ri, Rj, Rk) on the receiver side,
characterized by
a) transmission from the transmitter (TX) to the receiver (RX) of a training request message (TRAC, TRAD) comprising calibration information and formed on the transmitter side;
b) formation by the receiver (RX) of a channel property matrix from the calibration information and storage of the channel property matrix in the receiver (RX);
c) calculation of at least one item of compensation information based on a reference channel property matrix and the reference channel property matrix stored in the receiver (RX);
d) transmission of the compensation information from the receiver (RX) to the transmitter (TX).

2. The method as claimed in claim 1, characterized by the steps carried out before method step a)
a1) transmission of a compensation request message (RADCC, RACCC) comprising calibration information and formed on the transmitter side, from the transmitter (TX) to the receiver (RX),
a2) formation of a reference channel property matrix from said calibration information by the receiver (RX) and storage of the reference channel property matrix in the receiver (RX),
a3) transmission of an acknowledgement message (AACCC; AADCC) in response to the compensation request message from the receiver (RX) to the transmitter (TX).

3. The method as claimed in one of the preceding claims, characterized in that, based on the compensation information in the transmitter (TX), an adjustment of at least one transmission parameter is undertaken.

4. The method as claimed in one of the preceding claims, characterized in that the compensation information is a numerical vector comprising the diagonal elements of a matrix resulting from a left-sided multiplication of the inverted channel property matrix with the reference channel property matrix.

5. The method as claimed in claim 4, characterized in that the compensation information from the receiver (RX) to the transmitter (TX) is only sent if at least one vectorial element of the compensation information takes a value which essentially corresponds to a value not equal to one.

6. The method as claimed in claim 5, characterized in that at least one vectorial element of the compensation information takes a value not equal to one if the value of the vectorial element overshoots or undershoots the limits of a predeterminable confidence interval by a value of one.

7. The method as claimed in one of the preceding claims, characterized in that at least one secondary diagonal element of a matrix resulting from a multiplication of the inverted channel property matrix by the reference channel property matrix is tested as to whether the at least one secondary diagonal element substantially deviates from a value of zero.

8. The method as claimed in claim 7, characterized in that in the case of a substantial deviation of at least one secondary diagonal element of the matrix, an error message is transmitted.

9. The method as claimed in one of the preceding claims, characterized in that the training request message (TRAC, TRAD) comprises an identification which indicates, for a value of 0x0f, an alternating current-related training request message (TRAC) and, for a value of 0x10, a combined direct current-related and alternating current-related training request message (TRAD).

10. The method as claimed in one of the preceding claims, characterized in that transmission of the compensation information by the receiver (RX) to the transmitter (TX) is carried out by means of a compensation information message (CCAC, CCAD).

11. The method as claimed in claim 10, characterized in that the compensation information message (CCAC, CCAD) comprises an identifier which indicates, for a value of 0x0f, an alternating current-related compensation information message (CCAC) and, for a value of 0x10, a combined direct current-related and alternating current-related compensation information message (CCAD).

12. The method as claimed in one of the claims 2 to 11, characterized in that the acknowledgement message (AACCC, AADCC) comprises an identifier which indicates, for a value of 0x0f, an alternating current-related acknowledgement message (AACCC) and, for a value of 0x10, a combined direct current-related and alternating current-related acknowledgement message (AADCC).

13. The method as claimed in claims 2 to 12, characterized in that the acknowledgement message (AACCC, AADCC) comprises status and/or output feature information.

14. The method as claimed in one of the claims 2 to 13, characterized by the alternative step
a3) transmission of an acknowledgement message (AACCC; AADCC) in response to the compensation request message, from the receiver (RX) to the transmitter (TX) with an entry which indicates that the receiver (RX) is at least temporarily in a position to carry out a color stabilization method with regard to the alternating current characteristic and/or with regard to the direct current and alternating current characteristic of the quantum efficiency.

15. An optical transmission system for carrying out a method according to one of the preceding claims 1 to 8.
